(19) United States
(12) Patent Application Publication
(10) Pub. No.: US 2023/0214003 A1
(43) Pub. Date: Jul. 6, 2023

(54) CROSS-PLATFORM INTERACTION METHOD, AR DEVICE AND SERVER, AND VR DEVICE AND SERVER

(71) Applicant: GOERTEK INC., Shandong (CN)

(72) Inventors: Jiale SHANG, Shandong (CN); Bin JIANG, Shandong (CN); Xiaoyu CHI, Shandong (CN)

(73) Assignee: GOERTEK INC., Shandong (CN)

(21) Appl. No.: 17/996,461

(22) PCT Filed: Nov. 7, 2020
(86) PCT No.: PCT/CN2020/127361

§ 371 Date: Oct. 18, 2022

(30) Foreign Application Priority Data
May 25, 2020 (CN) 202010449860.9

(51) Int. Cl. G06F 3/01; H04L 67/131; H04L 67/02

(52) U.S. Cl. CPC G06F 3/011; H04L 67/131; H04L 67/02; G06T 19/006

(57) ABSTRACT

A cross-platform interaction method of VR and AR, AR device, AR server, VR device and VR server are disclosed. The method is applied to the AR server and comprises: acquiring first cross-platform interaction data corresponding to an AR client (S101); generating a first XML data interaction file corresponding to the first cross-platform interaction data (S102); and sending the first XML data interaction file to the VR server corresponding to a target VR client to enable the target VR client to perform a corresponding cooperative operation according to the first cross-platform interaction data (S103). The present disclosure uses the cross-platform characteristics of XML can realize the data interconnection between two platforms in the form of a lightweight database, improve the synchronization efficiency of cross-platform interaction data, realize standardized management of data from different platforms, and reduce resources used in the collaborative integration development of different VR and AR programs.

### CROSS-REFERENCE TO RELATED APPLICATIONS

This Application is a U.S. National-Stage entry under 35 U.S.C. § 371 based on International Application No. PCT/CN2020/127361, filed Nov. 7, 2020 which was published under PCT Article 21(2) and which claims priority to Chinese Application No. 202010449860.9, filed May 25, 2020, which are all hereby incorporated herein in their entirety by reference.

### TECHNICAL FIELD

This application pertains to the technical field of virtual reality and augmented reality, in particular to a cross-platform interaction method of VR and AR, AR device, AR server, VR device and VR server.

### BACKGROUND

The VR (Virtual Reality) technology can provide users with a highly immersive virtual reality environment, and thus can provide services for industrial training, simulation teaching and other fields with low cost and high simulation, however, the VR environment has a certain closeness. The AR (Augmented Reality) technology can superimpose the virtual reality and the real world in the form of augmented reality to realize the connection with the real world, however, the AR environment also has the limitation of insufficient immersion.

In the prior art, AR and VR collaborative interaction technologies mostly adopt the method of bottom-level integration, and often have problems such as low efficiency of cross-platform data synchronization, large consumption of resources and chaotic data management. These problems will lead to delays and crashes and other problems in the AR and VR collaborative process. Moreover, the investment in development is large, which is not conducive to the flexible access of third-party VR and AR programs. Therefore, how to use an efficient and stable cross-platform interaction method to realize the information and data interaction between VR and AR, reduce the resource consumption of the server, improve the efficiency of data synchronization, and further realize the flexible and efficient collaboration of multiple users on different platforms of AR and VR, is an urgent problem to be solved. In addition, other objects, desirable features and characteristics will become apparent from the subsequent summary and detailed description, and the appended claims, taken in conjunction with the accompanying drawings and this background.

### SUMMARY

The object of the present disclosure is to provide a cross-platform interaction method between VR and AR, AR device, AR server, VR device and VR server, so as to efficiently and stably realize the information and data interaction between VR and AR, reduce the resource consumption of the server and improve the efficiency of data synchronization.

To solve the above technical problems, the present disclosure provides a cross-platform interaction method between VR and AR, which is applied to AR server, comprising:

acquiring a first cross-platform interaction data corresponding to an AR client, wherein the first cross-platform interaction data includes at least one of user viewpoint information, model position information and user communication information;

generating a first XML data interaction file corresponding to the first cross-platform interaction data, wherein the first XML data interaction file is of a tree-node data structure; and

sending the first XML data interaction file to the VR server corresponding to a target VR client to enable the target VR client to perform a corresponding cooperative operation according to the first cross-platform interaction data.

Optionally, when the cross-platform interaction data includes the user viewpoint information, acquiring the first cross-platform interaction data corresponding to the AR client comprises:

acquiring the user viewpoint information corresponding to three-axis acceleration data collected by an acceleration sensor in earphones sent by the AR client.

Optionally, acquiring the user viewpoint information corresponding to the three-axis acceleration data collected by the acceleration sensor in the earphones sent by the AR client comprises:

receiving the three-axis acceleration data sent by the AR client; and

calculating the user viewpoint information according to the three-axis acceleration data.

Optionally, calculating the user viewpoint information according to the three-axis acceleration data comprises:

calculating a pitch angle, a yaw angle and a rollangle under an earphone coordinate system according to the three-axis acceleration data;

generating a rotation matrix corresponding to the pitch angle, the yaw angle and the roll angle; and

calculating the user viewpoint information by

$${P}_{user} = \frac{{P}_{world} - {T}_{offset}}{{R}_{Gsensor} {R}_{offset}} ,$$

where Pᵤₛₑᵣ is the user viewpoint information, P_{world} is a viewpoint position in the earphone coordinate system, R_{Gsensor} is the rotation matrix, T_{offset} is a preset translation offset amount, and R_{offset} is a preset rotation offset amount.

Optionally, receiving the three-axis acceleration data sent by the AR client comprises: receiving the three-axis acceleration data sent by the AR client which was sent to the AR client by the earphones via an SPP channel.

Optionally, the method further comprises:

receiving a second XML data interaction file sent by the VR server, wherein the second XML, data interaction file corresponds to second cross-platform interaction data corresponding to the target VR client;

acquiring the second cross-platform interaction data according to the second XML data interaction file; and

sending the second cross-platform interaction data to the AR client to enable the AR client to perform a cooperative operation corresponding to the second cross-platform interaction data.

Optionally, the method further comprises:

receiving intra-platform interaction data sent by an interactive AR client corresponding to the AR client; and

sending the intra-platform interaction data to the AR client to enable the AR client to perform a cooperative operation corresponding to the intra-platform interaction data.

Optionally, acquiring the first cross-platform interaction data corresponding to the AR client comprises:

receiving the first cross-platform interaction data sent by the AR client via RPC.

The present disclosure also provides an AR device, comprising:

an acquisition module for acquiring first cross-platform interaction data corresponding to an AR client, wherein the first cross-platform interaction data includes at least one of user viewpoint information, model position information and user communication information;

a generation module for generating a first XML, data interaction file corresponding to the first cross-platform interaction data, wherein the first XML data interaction file is of a tree-node data structure; and

a cross-platform sending module for sending the first XML data interaction file to the VR server corresponding to a target VR client to enable the target VR client to perform a corresponding cooperative operation according to the first cross-platform interaction data.

The present disclosure also provides an AR server comprising a memory and a processor, wherein the memory is for storing a computer program, and the processor is for realizing steps of the cross-platform interaction method of VR and AR applied to the AR server as described above when executing the computer program.

The present disclosure also provides a cross-platform interaction method between VR and AR, which is applied to a VR server, comprising:

receiving a first XML data interaction file sent by an AR server corresponding to a target AR client, wherein the first XML data interaction file is of a tree-node data structure;

acquiring first cross-platform interaction data corresponding to the first XML data interaction file, wherein the first cross-platform interaction data includes at least one of user viewpoint information, model position information and user communication information; and

sending the first cross-platform interaction data to a VR client corresponding to the target AR client to enable the VR client to perform the cooperative operation corresponding to the first cross-platform interaction data.

Optionally, the method further comprises:

acquiring second cross-platform interaction data corresponding to the VR client;

generating a second XML data interaction file corresponding to the second cross-platform interaction data; and

sending the second XML data interaction file to the AR server to enable the target AR client to perform a corresponding cooperative operation according to the second cross-platform interaction data.

Optionally, the method further comprises:

receiving intra-platform interaction data sent by an interactive VR client corresponding to the VR client; and

sending the intra-platform interaction data to the VR client to enable the VR client to perform a cooperative operation corresponding to the intra-platform interaction data.

Optionally, sending the first cross-platform interaction data to the VR client corresponding to the target AR client comprises:

sending the first cross-platform interaction data to the VR client via RPC.

The present disclosure also provides a VR device, comprising:

a receiving module for receiving a first XML data interaction file sent by an AR server corresponding to a target AR client, wherein the first XML data interaction file is of a tree-node data structure;

a parsing module for acquiring first cross-platform interaction data corresponding to the first XML data interaction file, wherein the first cross-platform interaction data includes at least one of user viewpoint information, model position information and user communication information; and

an intra-platform sending module for sending the first cross-platform interaction data to a VR client corresponding to the target AR client to enable the VR client to perform the cooperative operation corresponding to the first cross-platform interaction data.

The present disclosure also provides a VR server comprising a memory and a processor, wherein the memory is for storing a computer program, and the processor is for realizing steps of the cross-platform interaction method of VR and AR applied to the VR server as described above when executing the computer program.

The present disclosure provides a cross-platform interaction method between VR and AR, which is applied to AR server, comprising: acquiring first cross-platform interaction data corresponding to an AR client, wherein the first cross-platform interaction data includes at least one of user viewpoint information, model position information and user communication information; generating a first XML data interaction file corresponding to the first cross-platform interaction data, wherein the first XML data interaction file is of a tree-node data structure; and sending the first XML data interaction file to the VR server corresponding to a target VR client to enable the target VR client to perform a corresponding cooperative operation according to the first cross-platform interaction data.

Thus, the present disclosure generates the first XML data interaction file corresponding to the first cross-platform interaction data, and uses the cross-platform characteristics of XML (Extensible Markup Language) to organize the cross-platform interaction data of VR and AR through the tree-node data structure of XML language, so that it can realize the data interconnection between an AR platform and a VR platform in the form of a lightweight database, and realize the collaboration and data synchronization between the AR and VR platforms, thereby improves the synchronization efficiency of cross-platform interaction data between the VR and AR platforms, and realizes standardized management of data from different platforms. Moreover, due to the cross-platform characteristics of XML, it can reduce resources used in the collaborative integration development of different VR and AR programs, and improve the development efficiency. In addition, the present disclosure also provides a cross-platform interaction method of VR and AR applied to a VR server, AR device, AR server, VR device and VR server, which also have the above beneficial effects.

### BRIEF DESCRIPTION OF DRAWINGS

The present invention will hereinafter be described in conjunction with the following drawing figures, wherein like numerals denote like elements, and:

FIG. 1 is a flow chart of a cross-platform interaction method of VR and AR according to an embodiment of the present disclosure;

FIG. 2 is schematic diagram of the data structure of an XML data interaction file according to an embodiment of the present disclosure;

FIG. 3 is schematic diagram of the data example of an XML, data interaction file according to an embodiment of the present disclosure;

FIG. 4 is a flow chart of another cross-platform interaction method of VR and AR according to an embodiment of the present disclosure;

FIG. 5 is a schematic diagram of the architecture of another cross-platform interaction method of VR and AR according to an embodiment of the present disclosure;

FIG. 6 is a block diagram of the structure of an AR device according to an embodiment of the present disclosure;

FIG. 7 is a flow chart of another cross-platform interaction method of VR and AR according to an embodiment of the present disclosure; and

FIG. 8 is a block diagram of the structure of a VR device according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The technical solutions in embodiments of the present disclosure will be described below in conjunction with the drawings in the embodiments of the present disclosure. Obviously, the embodiments as described below are merely part of, rather than all, embodiments of the present disclosure. Based on the embodiments of the present disclosure, any other embodiment obtained by a person of ordinary skill in the art without paying any creative effort shall fall within the protection scope of the present disclosure.

In order to make the object, technical solutions and advantages of the embodiments of the present disclosure clearer, the technical solutions in the embodiments of the present disclosure will be described clearly and completely below in conjunction with the accompanying drawings in the embodiments of the present disclosure. Obviously, the embodiments as described below are merely part of, rather than all, embodiments of the present disclosure. Based on the embodiments of the present disclosure, any other embodiment obtained by a person of ordinary skill in the art without paying any creative effort shall fall within the protection scope of the present disclosure.

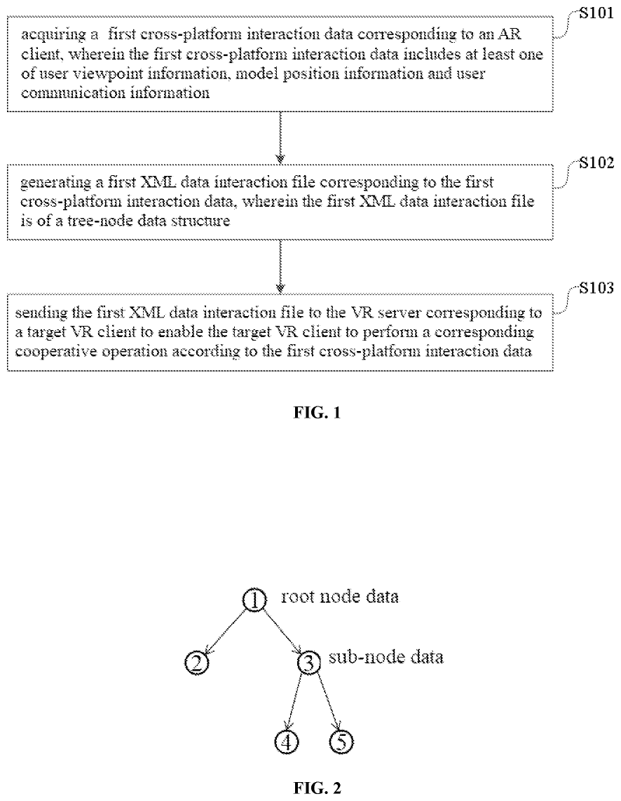

Please refer to FIG. 1 which is a flow chart of a cross-platform interaction method of VR and AR according to an embodiment of the present disclosure. The method is applied to an AR server, and may comprise:

Step 101: acquiring first cross-platform interaction data corresponding to an AR client. The first cross-platform interaction data includes at least one of user viewpoint information, model position information and user communication information.

It is understandable that the AR client in this step may be an AR device running an AR client program. The AR server in this embodiment may be the server corresponding to the AR client in the AR platform. The first cross-platform interaction data in this step may be the cross-platform interaction data that the AR client needs to send to the target client.

Specifically, the specific data content of the first cross-platform interaction data acquired by the AR server in this step, i.e., the specific data content of the cross-platform interaction data between the AR client of the AR platform and the VR client of the VR platform (i.e., the target VR client), may be set by the designer or user according to the practical scenarios and user needs. For example, the first cross-platform interaction data may include any one or more of the user viewpoint information used to reflect the change of the user's viewpoint, the model position information used to reflect the change of the relative coordinate position of the virtual model, and the user communication information (such as the user's language, text and other communication data). The first cross-platform interaction data may also include virtual model specific model data. There are not limitations on it in this embodiment.

Correspondingly, the specific method of acquiring, by the AR server, the first cross-platform interaction data corresponding to the AR client in this step may be set by the designer according to the practical scenarios and user needs. For example, the AR server may directly receive the first cross-platform interaction data collected by the AR client. Namely, before this step, the method may further comprise a step of collecting the first cross-platform interaction data by the AR client. For example, the AR client may collect the first cross-platform interaction data and send it to the AR server in the same or similar way as the prior art in which the AR client acquires the cross-platform interaction data that needs to be sent to the target VR client. In order to improve the accuracy of the user viewpoint information collected by the AR client, in this embodiment, the acceleration sensor (Gsensor) in the earphones (such as TWS earphones) connected to the AR client can be used as the input interface of the head pose data when the user uses the AR client, so as to provide more accurate user viewpoint information for the AR client. In other words, when the first cross-platform interaction data includes the user viewpoint information, the AR client may acquire the user viewpoint information corresponding to the three-axis acceleration data collected by the acceleration sensor in the earphones connected in pair, i.e., the AR client can use the three-axis acceleration data collected by the acceleration sensor in the received earphones to calculate the corresponding user viewpoint information; alternatively, it can directly receive the user viewpoint information corresponding to the three-axis acceleration data collected by the acceleration sensor sent by the earphones. The AR server may generate the first cross-platform interaction data corresponding to the AR client according to the original interaction data collected by the AR client. For example, when the first cross-platform interaction data includes the user viewpoint information, the AR server may generate the user viewpoint information corresponding to the AR client according to the three-axis acceleration data in the original interaction data collected by the AR client. In other words, the AR client collects the three-axis acceleration data collected by the acceleration sensor in the connected earphone. As long as the AR server can acquire the first cross-platform interaction data that the AR client needs to send to the target VR client, there are not limitations on it in this embodiment.

It should be noted that the specific method of acquiring, by the AR server, the user viewpoint information corresponding to the three-axis acceleration data collected by the acceleration sensor in the earphones connected to the AR client may be set by the designer. The AR server may directly receive the three-axis acceleration data collected by the acceleration sensor in the earphones connected to the AR client sent by the AR client; according to the received three-axis acceleration data, a pitch angle, a yaw angle and a roll angle in the earphone coordinate system are calculated; a rotation matrix corresponding to the pitch angle, the yaw angle and the roll angle is generated; the user viewpoint information is calculated by

$${P}_{user} = \frac{{P}_{world} - {T}_{offset}}{{R}_{Gsensor} {R}_{offset}} ,$$

where Pᵤₛₑᵣ is the user viewpoint information, P_{world} is a viewpoint position in the earphone coordinate system, R_{Gsensor} is the rotation matrix, T_{offset} is a preset translation offset amount, and R_{offset} is a preset rotation offset amount. Alternatively, the AR server may receive the pitch angle, the yaw angle and the roll angle under the earphone coordinate system corresponding to the three-axis acceleration data collected by the acceleration sensor in the earphones connected by the AR client sent by the AR client; a rotation matrix corresponding to the pitch angle, the yaw angle and the roll angle is generated; the user viewpoint information is calculated by

$${P}_{user} = \frac{{P}_{world} - {T}_{offset}}{{R}_{Gsensor} {R}_{offset}} .$$

Alternatively, the AR client may directly receive the user viewpoint information corresponding to the three-axis acceleration data collected by the acceleration sensor in the earphones sent by the earphones. Alternatively, the AR server may receive the user viewpoint information corresponding to the three-axis acceleration data collected by the acceleration sensor in the earphones connected to the AR client sent by the AR client, namely, the processors in the earphones connected to the AR client or the AR client can calculate the user viewpoint information corresponding to the three-axis acceleration data collected by the acceleration sensor in the earphones.

For example, when a user uses a mobile phone (i.e., AR client) as an AR device to use an AR application (i.e., AR client program) and a VR platform to perform the virtual collaborative assembly in the industrial field, the Gsensor (acceleration sensor) of the main earphone of the TWS earphones paired with the mobile phone will open its own FIFO (first in first out data buffer) to collect the acceleration data of the earphones on the XYZ axis. Then, the feature quantities are extracted after denoising such as filtering. Then, based on the acceleration information of each axis contained in these feature quantities, the pitch angle, the yaw angle and the roll angle of TWS earphone in its own coordinate system are calculated. The angles at each sampling moment may be calculated as follows:

α1=arctan(Ax/squr(Ay*Ay+Az*Az))

β1=arctan(Ay/squr(Ax*Ax+Az*Az))

γ1=arctan(Az/squr(Ax*Ax+Ay*Ay))

In the above formula, α1, β1 and γ1 may respectively represent the pitch angle, the yaw angle and the roll angle of the Gsensor at the sampling moment when the user performs encryption action on the X, Y and Z axes; Ax is the acceleration component on the X axis at the current sampling moment, Ay is the acceleration component on the Y axis at the current sampling moment, and Az is the acceleration component on the Z axis at the current sampling moment. These angle information is represented by the rotation matrix R_{Gsensor}. Since there is a certain offset between the coordinates of the TWS earphones and the coordinates of the viewpoint center of the user's head, the calculated R_{Gsensor} is converted from the TWS earphone coordinates to the user's viewpoint center coordinates by setting the R_{offset} and T_{offset}, so as to obtain the R_{Gsensor} representing the 6Dof rotation amount of the user's viewpoint under the current data collection window, i.e., P_{world}. The viewpoint position Pᵤₛₑᵣ in the user viewpoint center coordinate system and the viewpoint position in the world coordinate system (i.e., TWS earphone coordinates) have the following relationship:

P_{world}=R_{Gsensor}R_{offset}PᵤₛₑᵣT_{offset}

Further, in order to improve the synchronization efficiency of cross-platform interaction data between the VR and AR platforms, when the earphones paired with the AR client are Bluetooth earphones (such as TWS earphones), the AR client may receive the data sent by the earphones via the SPP (serial port profile) data transmission channel in Bluetooth protocol. For example, the AR client may receive the three-axis acceleration data sent by the earphones via the SPP channel, namely, the AR server may receive, from the AR client, the three-axis acceleration data that is sent by the earphones to the AR client via the SPP channel. Alternatively, the AR client may receive the user viewpoint information corresponding to the three-axis acceleration data sent by the earphones via the SPP channel, namely, the AR server may receive, from the AR client, the user viewpoint information corresponding to the three-axis acceleration data that is sent by the earphones to the AR client via the SPP channel.

Step 102: generating a first XML data interaction file corresponding to the first cross-platform interaction data. The first XML data interaction file is of a tree-node data structure.

It is understandable that the purpose of this step may be to organize the cross-platform interaction data (i.e., the first cross-platform interaction data) that the AR client needs to send to the target VR client for the AR server in the tree-node data structure of XML language to obtain the corresponding XML data interaction file (i.e., the first XML data interaction file), so that the VR platform and the AR platform can establish a lightweight database by XML for data synchronization between platforms.

For example, in the virtual reality assembly application in the industrial field, when a complex industrial device such as an engine is virtually assembled, a single VR environment may not be able to achieve flexible collaboration in multiple fields because of its closeness. At this point, the method according to this embodiment may organize the relevant data of the engine model according to the tree data structure shown in FIG. 2. For example, the AR server of the AR platform may generate the XML data interaction file (i.e., the first XML data interaction file) corresponding to the relative coordinate position information (i.e., the model position information) of the virtual model of the engine, and send it to the VR server corresponding to the VR client (i.e., the target VR client) of the VR platform, so that the VR server can synchronize the corresponding model data in the VR platform by reading and parsing the XML data interaction file, the target VR client can acquire the relative coordinate position information of the virtual model, and thus different users can realize real-time synchronous collaboration on the dual platforms of AR and VR.

Specifically, the assembled components in FIG. 3 may be the root node data in FIG. 2, the component name and component origin coordinates in FIG. 3 may be the sub-node data in FIG. 2, and the specific coordinates “X”, “Y” and “Z” in FIG. 3 may be the data under the sub-node data of “component origin coordinates”.

Step 103: sending the first XML data interaction file to the VR server corresponding to a target VR client to enable the target VR client to perform a corresponding cooperative operation according to the first cross-platform interaction data.

It can be understood that the target VR client in this step may be the VR client that needs to perform corresponding cooperative operation according to the first cross-platform interaction data sent by the AR client, i.e., the VR client corresponding to the target address of the first cross-platform interaction data sent by the AR client. The VR server corresponding to the target VR client in this step may be the VR server that receives the first XML data interaction file sent by the AR server and sends the first cross-platform interaction data obtained by parsing the first XML data interaction file to the target VR client.

Correspondingly, after this step, the method may further comprise: acquiring, by the VR server, the first cross-platform interaction data corresponding to the received first XML data interaction file, and sending the first cross-platform interaction data to the target VR client; performing, by the target VR client, the cooperative operation corresponding to the first cross-platform interaction data.

Specifically, in this embodiment, the target VR client may perform a corresponding cooperative operation according to the first cross-platform interaction data received. For example, the target VR client may synchronize the model position of the corresponding virtual model according to the model position information in the first cross-platform interaction data. Alternatively, the target VR client may synchronize the rendering angle of the corresponding virtual model according to the user viewpoint information in the first cross-platform interaction data. Alternatively, the target VR client may receive user communication information in the first cross-platform interaction data, and the display displays the corresponding text or the speaker plays the corresponding voice.

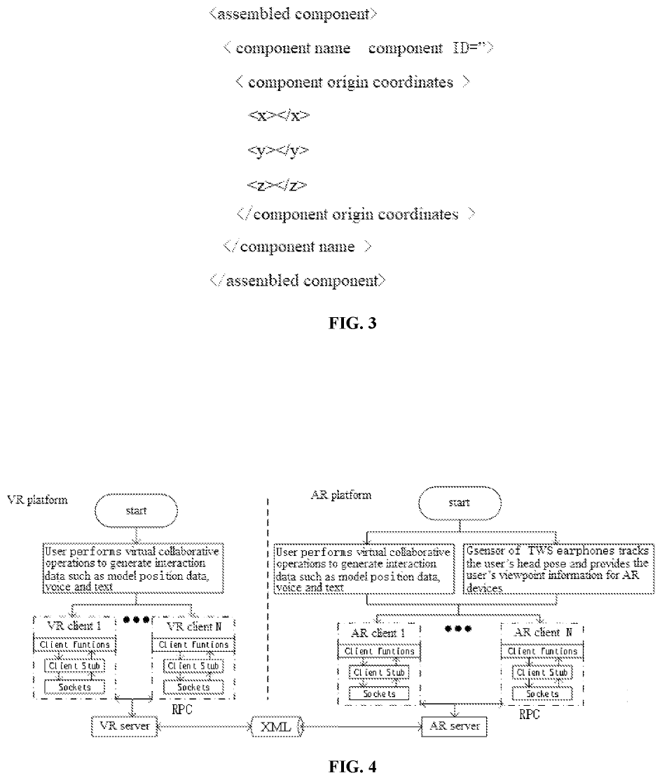

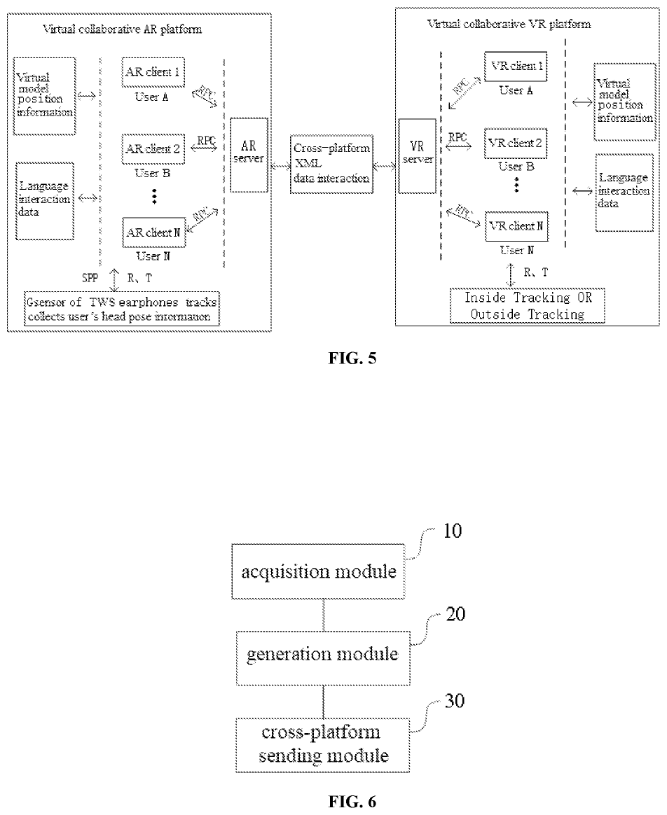

Furthermore, since the traditional multi-person collaboration system is often developed based on HTTP (Hyper Text Transfer Protocol), this method will generate much useless information in the data synchronization process of multi-person VR and AR collaboration, and the byte size, serialization and other operations will cost more performance. Therefore, in this embodiment, in order to improve the synchronization efficiency of cross-platform interaction data between VR and AR platforms, the AR client may send the first cross-platform interaction data to the AR server (i.e., the AR server) via RPC (Remote Procedure Call Protocol), which can avoid redundant operations in data synchronization such as three-way handshake of http, and perform data synchronization in the multi-person collaboration process with higher performance. In other words, the step 101 may be that the AR server receives the first cross-platform interaction data sent by the AR client via RPC. As shown in FIG. 4 and FIG. 5, the AR client in the AR platform can send the first cross-platform interaction data to the AR server via RPC, and the AR server forwards the first XML data interaction file corresponding to the generated first cross-platform interaction data to the VR server corresponding to the target VR client, then the VR server sends the first cross-platform interaction data corresponding to the parsed first XML data interaction file to the corresponding VR client (i.e., the target VR client) via RPC.

It should be noted that the cross-platform interaction method of VR and AR according to this embodiment may further comprise the step of performing, by the AR client, a corresponding cooperative operation according to the received second cross-platform interaction data sent by the VR client, so as to realize the two-way interaction and collaboration between the VR platform and the AR platform. For example, the AR server can receive the second XML data interaction file sent by the VR server, wherein the second XML data interaction file corresponds to the second cross-platform interaction data corresponding to the target VR client; acquiring the second cross-platform interaction data according to the second XML data interaction file; sending the second cross-platform interaction data to the AR client to enable the AR client to perform the cooperative operation corresponding to the second cross-platform interaction data. In other words, the AR client may receive the second cross-platform interaction data sent by the target VR client and perform the cooperative operation corresponding to the second cross-platform interaction data. Accordingly, the AR client may receive the second XML data interaction file sent by the target VR client from the AR server via RPC.

The second cross-platform interaction data may be the cross-platform interaction data sent by the VR client (such as the target VR client) to the AR client. The specific data type of the second cross-platform interaction data may be the same or similar to the first cross-platform interaction data. For example, the second cross-platform interaction data may also include at least one of the user viewpoint information, model position information and user communication information. The second XML data interaction file corresponding to the second cross-platform interaction data may be the XML data interaction file corresponding to the second cross-platform interaction data generated by the VR client corresponding to the VR client, i.e., the second cross-platform interaction data organized in the tree-node data structure of XML, language.

Correspondingly, the cross-platform interaction method of VR and AR according to this embodiment may further comprise: receiving, by the AR server, intra-platform interaction data sent by an interactive AR client corresponding to the AR client; sending the intra-platform interaction data to the AR client, so that the AR client can perform a cooperative operation corresponding to the intra-platform interaction data. In other words, the AR client performs a cooperative operation corresponding to the intra-platform interaction data according to the received intra-platform interaction data sent by other AR clients (i.e., interactive AR clients) that need to interact with the AR client. In other words, the AR client and the interactive AR client may send intra-platform interaction data to each other to achieve collaboration and data synchronization within the intra-platform. For example, the interactive AR client may send the intra-platform interaction data to the AR server via RPC, so that the AR server can forward the intra-platform interaction data to the AR client via RPC, namely, the AR client may receive the intra-platform interaction data sent by the interactive AR client from the AR server via RPC. Correspondingly, the AR client may also send the intra-platform interaction data that it needs to send to the interactive AR client to the AR server via RPC, so as to forward it to the interactive AR client.

The intra-platform interaction data sent by the interactive AR client may be the data of interaction and collaboration between AR clients in the AR platform. The specific data type of the intra-platform interaction data may be the same or similar to the second cross-platform interaction data and the first cross-platform interaction data. For example, the intra-platform interaction data may also include at least one of user viewpoint information, model position information and user communication information.

In this embodiment, the present disclosure generates the first XML data interaction file corresponding to the first cross-platform interaction data, and uses the cross-platform characteristics of XML (Extensible Markup Language) to organize the cross-platform interaction data of VR and AR through the tree-node data structure of XML language, so that it can realize the data interconnection between an AR platform and a VR platform in the form of a lightweight database, and realize the collaboration and data synchronization between the AR and VR platforms, thereby improves the synchronization efficiency of cross-platform interaction data between the VR and AR platforms, and realizes standardized management of data from different platforms. Moreover, due to the cross-platform characteristics of XML, it can reduce resources used in the collaborative integration development of different VR and AR programs, and increase the development efficiency.

Corresponding to the above method embodiment, the present disclosure also provides an AR device. The AR device described below and the cross-platform interaction method of VR and AR described above are corresponding and can refer to each other.

Referring to FIG. 6, the AR device may comprise:

an acquisition module 10 for acquiring first cross-platform interaction data corresponding to an AR client, wherein the first cross-platform interaction data includes at least one of user viewpoint information, model position information and user communication information;

a generation module 20 for generating a first XML data interaction file corresponding to the first cross-platform interaction data, wherein the first XML data interaction file is of a tree-node data structure; and

a cross-platform sending module 30 for sending the first XML data interaction file to the VR server corresponding to a target VR client to enable the target VR client to perform a corresponding cooperative operation according to the first cross-platform interaction data.

Optionally, when the cross-platform interaction data includes the user viewpoint information, the acquisition module 10 may be specifically for acquiring the user viewpoint information corresponding to three-axis acceleration data collected by an acceleration sensor in earphones sent by the AR client.

Optionally, the acquisition module 10 may comprise:

a receiving sub-module for receiving the three-axis acceleration data sent by the AR client; and

a calculation sub-module for calculating the user viewpoint information according to the three-axis acceleration data.

Optionally, the calculation sub-module may comprise:

an angle calculation unit for calculating a pitch angle, a yaw angle and a roll angle under an earphone coordinate system according to the three-axis acceleration data;

a generation and calculation unit for generating a rotation matrix corresponding to the pitch angle, the yaw angle and the roll angle; and

a viewpoint calculation unit for calculating the user viewpoint information by

$${P}_{user} = \frac{{P}_{world} - {T}_{offset}}{{R}_{Gsensor} {R}_{offset}} ,$$

where Puser is the user viewpoint information, Pworld is a viewpoint position in the earphone coordinate system, RGsensor is the rotation matrix, Toffset is a preset translation offset amount, and Roffset is a preset rotation offset amount.

Optionally, the receiving sub-module may be specifically for receiving the three-axis acceleration data sent by the AR client which was sent to the AR client by the earphones via an SPP channel.

Optionally, the AR device may further comprise:

a cross-platform receiving module for receiving a second XML data interaction file sent by the VR server, wherein the second XML data interaction file corresponds to second cross-platform interaction data corresponding to the target VR client;

a cross-platform generation module for acquiring the second cross-platform interaction data according to the second XML data interaction file; and

a cross-platform execution module for sending the second cross-platform interaction data to the AR client to enable the AR client to perform a cooperative operation corresponding to the second cross-platform interaction data.

Optionally, the AR device may further comprise:

a first intra-platform receiving module for receiving intra-platform interaction data sent by an interactive AR client corresponding to the AR client; and

a first intra-platform execution module for sending the intra-platform interaction data to the AR client to enable the AR client to perform a cooperative operation corresponding to the intra-platform interaction data.

Optionally, the acquisition module 10 may be specifically for receiving the first cross-platform interaction data sent by the AR client via RPC.

In this embodiment, the present disclosure generates the first XML data interaction file corresponding to the first cross-platform interaction data via the generation module 20, and uses the cross-platform characteristics of XML (Extensible Markup Language) to organize the cross-platform interaction data of VR and AR through the tree-node data structure of XML language, so that it can realize the data interconnection between an AR platform and a VR platform in the form of a lightweight database, and realize the collaboration and data synchronization between the AR and VR platforms, thereby improves the synchronization efficiency of cross-platform interaction data between the VR and AR platforms, and realizes standardized management of data from different platforms. Moreover, due to the cross-platform characteristics of XML, it can reduce resources used in the collaborative integration development of different VR and AR programs, and increase the development efficiency.

Corresponding to the above method embodiments, the embodiments of the present disclosure also provide an AR server comprising a memory and a processor. The memory is configured to store the computer program, and the processor is configured to realize steps of the cross-platform interaction method of VR and AR applied to the AR server as described above when executing the computer program.

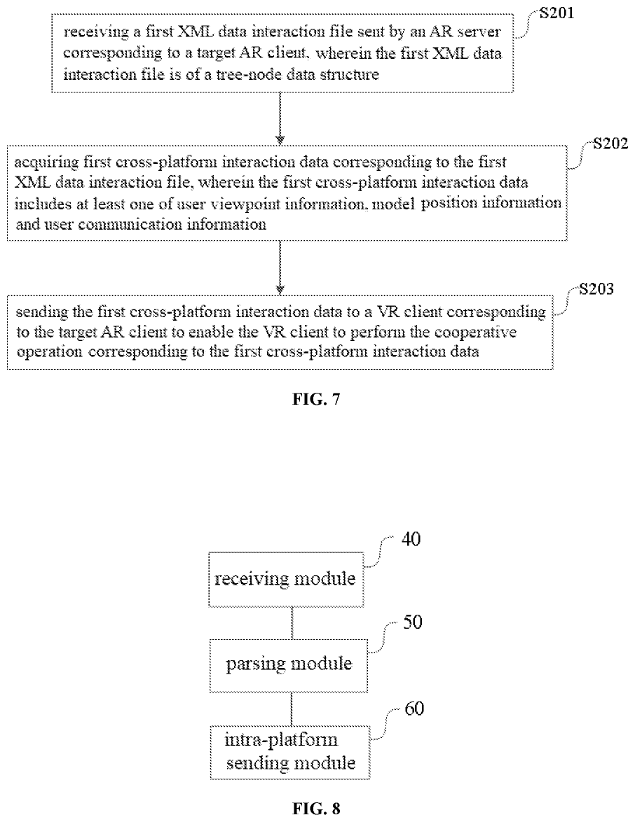

Referring to FIG. 7, which is the flow chart of another cross-platform interaction method of VR and AR according to an embodiment of the present disclosure. This method is applied to a VR server and may comprise:

Step 201: receiving a first XML data interaction file sent by an AR server corresponding to a target AR client. The first XML data interaction file is of a tree-node data structure.

It is understandable that the VR client in this step may be a VR device running a VR client program. The VR server in this embodiment may be a server corresponding to the VR client in the VR platform. The target AR client in this step may be the AR client that needs to perform cooperative operation with the VR client.

Specifically, the specific data content of the first XML data interaction file in this step corresponds to the first XML data interaction file in the above cross-platform interaction method of VR and AR applied to AR server, and will not be repeated here.

Step 202: acquiring first cross-platform interaction data corresponding to the first XML data interaction file. The first cross-platform interaction data includes at least one of user viewpoint information, model position information and user communication information.

Specifically, the specific data content of the first cross-platform interaction data in this step corresponds to the first cross-platform interaction data in the above VR and AR cross-platform interaction methods applied to the AR server, and will not be repeated here.

It is understandable that the purpose of this step may be that the VR client, by parsing the first XML data interaction file received, obtains the first cross-platform interaction data that the target AR client needs to send to the AR client.

Step 203: sending the first cross-platform interaction data to a VR client corresponding to the target AR client to enable the VR client to perform the cooperative operation corresponding to the first cross-platform interaction data.

It is understandable that the purpose of this step may be that the VR server sends the first cross-platform interaction data to the VR client corresponding to the target AR client, i.e., the VR client that the target AR client needs to interact with, so that the VR client can perform the cooperative operation corresponding to the first cross-platform interaction data received, and complete the cross-platform interaction between the target AR client and the VR client. Correspondingly, after this step, the method may further comprise: performing, by the VR client, a cooperative operation corresponding to the first cross-platform interaction data.

It should be noted that the cross-platform interaction method of VR and AR according to this embodiment may further comprise: acquiring second cross-platform interaction data corresponding to the VR client; generating a second XML data interaction file corresponding to the second cross-platform interaction data; and sending the second XML data interaction file to the AR server to enable the target AR client to perform a corresponding cooperative operation according to the second cross-platform interaction data. Accordingly, the specific process of generating, by the VR server, the second XML data interaction file and sending it to the target AR client is similar to the specific process of generating, by the AR server, the first XML data interaction file and sending it to the target VR client in the above cross-platform interaction method of VR and AR applied to the AR server, and will not be repeated here.

Correspondingly, the cross-platform interaction method of VR and AR according to this embodiment may further comprise: receiving, by the VR server, intra-platform interaction data sent by an interactive VR client corresponding to the VR client; sending the intra-platform interaction data to the VR client, so that the VR client performs a cooperative operation corresponding to the intra-platform interaction data. In other words, the VR client performs a cooperative operation corresponding to the intra-platform interaction data according to the received intra-platform interaction data sent by other VR clients (i.e., interactive VR clients) that need to interact with the VR client. In other words, the VR client and the interactive VR client may send intra-platform interaction data to each other to achieve collaboration and data synchronization within the intra-platform. For example, the interactive VR client may send the intra-platform interaction data to the VR server via RPC, so that the VR server can forward the intra-platform interaction data to the VR client via RPC, namely, the VR client may receive the intra-platform interaction data sent by the interactive VR client from the VR server via RPC. Correspondingly, the VR client may also send the intra-platform interaction data that it needs to send to the interactive VR client to the VR server via RPC, so as to forward it to the interactive VR client.

The intra-platform interaction data sent by the interactive VR client may be the data of interaction and collaboration between VR clients in the VR platforms. The specific data type of the intra-platform interaction data may be the same or similar to the second cross-platform interaction data and the first cross-platform interaction data. For example, the intra-platform interaction data may also include at least one of user viewpoint information, model position information and user communication information.

In this embodiment, the present disclosure receives the first XML data interaction file sent by the AR server corresponding to the target AR client via the VR server, and uses the cross-platform characteristics of XML (Extensible Markup Language) to organize the cross-platform interaction data of VR and AR through the tree-node data structure of XML language, so that it can realize the data interconnection between an AR platform and a VR platform in the form of a lightweight database, and realize the collaboration and data synchronization between the AR and VR platforms, thereby improves the synchronization efficiency of cross-platform interaction data between the VR and AR platforms, and realizes standardized management of data from different platforms. Moreover, due to the cross-platform characteristics of XML, it can reduce resources used in the collaborative integration development of different VR and AR programs, and increase the development efficiency.

Corresponding to the above method embodiment applied to the VR server, the present disclosure also provides a VR device. The VR device described below and the cross-platform interaction method of VR and AR applied to the VR server described above are corresponding and can refer to each other.

Referring to FIG. 8, the VR device may comprise:

a receiving module 40 for receiving a first XML data interaction file sent by an AR server corresponding to a target AR client, wherein the first XML data interaction file is of a tree-node data structure;

a parsing module 50 for acquiring first cross-platform interaction data corresponding to the first XML data interaction file, wherein the first cross-platform interaction data includes at least one of user viewpoint information, model position information and user communication information; and

an intra-platform sending module 60 for sending the first cross-platform interaction data to a VR client corresponding to the target AR client to enable the VR client to perform the cooperative operation corresponding to the first cross-platform interaction data.

Optionally, the VR device may further comprise:

a cross-platform acquisition module for acquiring second cross-platform interaction data corresponding to the VR client;

a cross-platform conversion module for generating a second XML data interaction file corresponding to the second cross-platform interaction data; and

a cross-platform forwarding module for sending the second XML data interaction file to the AR server to enable the target AR client to perform a corresponding cooperative operation according to the second cross-platform interaction data.

Optionally, the VR device may further comprise:

a second intra-platform receiving module for receiving intra-platform interaction data sent by an interactive VR client corresponding to the VR client; and

a second intra-platform execution module for sending the intra-platform interaction data to the VR client to enable the VR client to perform a cooperative operation corresponding to the intra-platform interaction data.

Optionally, the intra-platform sending module 60 can be specifically for sending the first cross-platform interaction data to the VR client via RPC.

In this embodiment, the present disclosure receives the first XML data interaction file sent by the AR server corresponding to the target AR client via the receiving module 40, and uses the cross-platform characteristics of XML (Extensible Markup Language) to organize the cross-platform interaction data of VR and AR through the tree-node data structure of XML language, so that it can realize the data interconnection between an AR platform and a VR platform in the form of a lightweight database, and realize the collaboration and data synchronization between the AR and VR platforms, thereby improves the synchronization efficiency of cross-platform interaction data between the VR and AR platforms, and realizes standardized management of data from different platforms. Moreover, due to the cross-platform characteristics of XML, it can reduce resources used in the collaborative integration development of different VR and AR programs, and increase the development efficiency.

Corresponding to the above method embodiment applied to the VR server, the present disclosure also provides a VR server comprising a memory and a processor. The memory is configured to store a computer program, and the processor is configured to realize steps of the cross-platform interaction method of VR and AR applied to the VR server as described above when executing the computer program.

Each embodiment in the specification is described in a progressive manner, and focuses on the differences from other embodiments. The same and similar parts of the embodiments may refer to each other. For the device and server disclosed in the embodiments, since they correspond to the method disclosed in the embodiments, the description is relatively simple. Please refer to the description of the method section for relevant parts.

The steps of a method or algorithm described in connection with the embodiments disclosed herein may be implemented directly with hardware, a software module executed by a processor, or a combination of the two. The software module may be placed in a random access memory (RAM), a memory, a read only memory (ROM), an electrically programmable ROM, an electrically erasable programmable ROM, a register, a hard disk, a removable disk, a CD-ROM, or any other form of storage medium known in the art.

The embodiments in this specification are described in a parallel or progressive manner. Each embodiment focuses on the differences from other embodiments. The same or similar parts of the embodiments may refer to each other. As for the device disclosed in the embodiment, since it corresponds to the method disclosed in the embodiment, the description is relatively simple. See the description of the method section for relevant parts.

Those skilled in the art can also understand that the units and algorithm steps of the examples described in combination with the embodiments disclosed herein can be implemented in electronic hardware, computer software or a combination of the two. In order to clearly illustrate the interchangeability of hardware and software, the composition and steps of the examples have been generally described in the above description according to functions. Whether these functions are performed in hardware or software depends on the specific application and design constraints of the technical solution. Professional technicians may use different methods to realize the described functions for each specific application, but such realization shall not be considered beyond the scope of the present disclosure.

The steps of a method or algorithm described in conjunction with the embodiments disclosed herein may be directly implemented by hardware, by software module executed by a processor, or by a combination of the two. The software module may be placed in a random access memory (RAM), a memory, a read only memory (ROM), an electrically programmable ROM, an electrically erasable programmable ROM, a register, a hard disk, a removable disk, a CD-ROM, or any other form of storage medium known in the art.

It should also be noted that, relational terms such as first and second used herein are only to distinguish one entity or operation from another, and do not necessarily require or imply that there is such actual relationship or order among those entities or operations. Moreover, the terms “comprise”, “include” or any other variants are intended to cover non-exclusive inclusion, so that the process, method, article or apparatus including a series of elements may not only include those elements, but may also include other elements not stated explicitly, or elements inherent to the process, method, article or apparatus. Without more limitations, an element defined by the phrase “comprising a . . . ” does not exclude the case that there are other same elements in the process, method, article or apparatus including the element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A cross-platform interaction method between VR and AR, which is applied to AR server, comprising:
acquiring a first cross-platform interaction data corresponding to an AR client, wherein the first cross-platform interaction data includes at least one of user viewpoint information, model position information and user communication information;
generating a first XML data interaction file corresponding to the first cross-platform interaction data, wherein the first XML data interaction file is of a tree-node data structure; and
sending the first XML data interaction file to the VR server corresponding to a target VR client to enable the target VR client to perform a corresponding cooperative operation according to the first cross-platform interaction data.

2. The cross-platform interaction method of VR and AR according to claim 1, wherein when the cross-platform interaction data includes the user viewpoint information, acquiring the first cross-platform interaction data corresponding to the AR client comprises:
acquiring the user viewpoint information corresponding to three-axis acceleration data collected by an acceleration sensor in earphones sent by the AR client.

3. The cross-platform interaction method of VR and AR according to claim 2, wherein acquiring the user viewpoint information corresponding to the three-axis acceleration data collected by the acceleration sensor in the earphones sent by the AR client comprises:
receiving the three-axis acceleration data sent by the AR client; and
calculating the user viewpoint information according to the three-axis acceleration data.

4. The cross-platform interaction method of VR and AR according to claim 3, wherein calculating the user viewpoint information according to the three-axis acceleration data comprises:
calculating a pitch angle, a yaw angle and a roll angle under an earphone coordinate system according to the three-axis acceleration data;
generating a rotation matrix corresponding to the pitch angle, the yaw angle and the roll angle; and
calculating the user viewpoint information by
$${P}_{user} = \frac{{P}_{world} - {T}_{offset}}{{R}_{Gsensor} {R}_{offset}} ,$$
where Pᵤₛₑᵣ is the user viewpoint information, P_{world} is a viewpoint position in the earphone coordinate system, R_{Gsensor} is the rotation matrix, T_{offset} is a preset translation offset amount, and R_{offset} is a preset rotation offset amount.

5. The cross-platform interaction method of VR and AR according to claim 3, wherein receiving the three-axis acceleration data sent by the AR client comprises:
receiving the three-axis acceleration data sent by the AR client which was sent to the AR client by the earphones via an SPP channel.

6. The cross-platform interaction method of VR and AR according to claim 1, further comprising:
receiving a second XML data interaction file sent by the VR server, wherein the second XML data interaction file corresponds to second cross-platform interaction data corresponding to the target VR client;
acquiring the second cross-platform interaction data according to the second XML data interaction file; and
sending the second cross-platform interaction data to the AR client to enable the AR client to perform a cooperative operation corresponding to the second cross-platform interaction data.

7. The cross-platform interaction method of VR and AR according to claim 1, further comprising:
receiving intra-platform interaction data sent by an interactive AR client corresponding to the AR client; and
sending the intra-platform interaction data to the AR client to enable the AR client to perform a cooperative operation corresponding to the intra-platform interaction data.

8. The cross-platform interaction method of VR and AR according to claim 1, wherein acquiring the first cross-platform interaction data corresponding to the AR client comprises:
receiving the first cross-platform interaction data sent by the AR client via RPC.

9. (canceled)

10. An AR server, comprising a memory and a processor, wherein the memory is for storing a computer program, and the processor is for realizing steps of the cross-platform interaction method of VR and AR according to claim 1 when executing the computer program.

11. A cross-platform interaction method between VR and AR, which is applied to a VR server, comprising:
receiving a first XML data interaction file sent by an AR server corresponding to a target AR client, wherein the first XML data interaction file is of a tree-node data structure;
acquiring first cross-platform interaction data corresponding to the first XML data interaction file, wherein the first cross-platform interaction data includes at least one of user viewpoint information, model position information and user communication information; and
sending the first cross-platform interaction data to a VR client corresponding to the target AR client to enable the VR client to perform the cooperative operation corresponding to the first cross-platform interaction data.

12. The cross-platform interaction method of VR and AR according to claim 11, further comprising:
acquiring second cross-platform interaction data corresponding to the VR client;
generating a second XML data interaction file corresponding to the second cross-platform interaction data; and
sending the second XML data interaction file to the AR server to enable the target AR client to perform a corresponding cooperative operation according to the second cross-platform interaction data.

13. The cross-platform interaction method of VR and AR according to claim 11, further comprising:
receiving intra-platform interaction data sent by an interactive VR client corresponding to the VR client; and
sending the intra-platform interaction data to the VR client to enable the VR client to perform a cooperative operation corresponding to the intra-platform interaction data.

14. The cross-platform interaction method of VR and AR according to claim 11, wherein sending the first cross-platform interaction data to the VR client corresponding to the target AR client comprises:
sending the first cross-platform interaction data to the VR client via RPC.

15-16. (canceled)

17. The cross-platform interaction method of VR and AR according to claim 2, wherein acquiring the first cross-platform interaction data corresponding to the AR client comprises:
receiving the first cross-platform interaction data sent by the AR client via RPC.

18. The cross-platform interaction method of VR and AR according to claim 6, wherein acquiring the first cross-platform interaction data corresponding to the AR client comprises:
receiving the first cross-platform interaction data sent by the AR client via RPC.

19. The cross-platform interaction method of VR and AR according to claim 7, wherein acquiring the first cross-platform interaction data corresponding to the AR client comprises:
receiving the first cross-platform interaction data sent by the AR client via RPC.

20. An AR server, comprising a memory and a processor, wherein the memory is for storing a computer program, and the processor is for realizing steps of the cross-platform interaction method of VR and AR according to claim 2 when executing the computer program.

21. An AR server, comprising a memory and a processor, wherein the memory is for storing a computer program, and the processor is for realizing steps of the cross-platform interaction method of VR and AR according to claim 6 when executing the computer program.

22. The cross-platform interaction method of VR and AR according to claim 12, wherein sending the first cross-platform interaction data to the VR client corresponding to the target AR client comprises:
sending the first cross-platform interaction data to the VR client via RPC.

23. The cross-platform interaction method of VR and AR according to claim 13, wherein sending the first cross-platform interaction data to the VR client corresponding to the target AR client comprises:
sending the first cross-platform interaction data to the VR client via RPC.
